(19) United States
(12) Patent Application Publication
(10) Pub. No.: US 2017/0061466 A1
(43) Pub. Date: Mar. 2, 2017

(54) NFC ENABLED MOBILE PAYMENT INCORPORATING AUTOMATIC REDEMPTION OF VALUE ADDED SERVICES

(71) Applicant: MASTERCARD ASIA/PACIFIC PTE LTD., Singapore (SG)

(72) Inventor: Abhinava SRIVASTAVA, Stamford, CT (US)

(73) Assignee: MASTERCARD ASIA/PACIFIC PTE LTD., Singapore (SG)

(21) Appl. No.: 15/248,446

(22) Filed: Aug. 26, 2016

(30) Foreign Application Priority Data
Aug. 28, 2015 (SG) 10201506846S

(51) Int. Cl. G06Q 30/02; G06Q 20/32; G06Q 20/20

(52) U.S. Cl. CPC G06Q 30/0238; G06Q 20/202; G06Q 20/3278

(57) ABSTRACT

Methods and associated devices are provided for NFC enabled mobile payment incorporating automatic redemption of value added services. A method comprising pre-tap processing at the NFC enabled mobile device to load one or more selected value added services into the NFC enabled mobile device; and placing the NFC enabled mobile device in proximity to the NFC enabled payment machine so as to initiate and complete the one-tap settlement where data is exchanged so as to process the purchase of goods or services utilizing the redeemed one or more of the selected value added services loaded during the pre-tap processing to bring about the at least one effect provided by the redemption of one or more selected value added services.

### FIELD OF INVENTION

The following discloses Near Field Communication (NFC) enabled mobile payment that incorporates automatic redemption of value added services and methods for enabling such automatic redemption of value added services.

### BACKGROUND

Value added services (VAS), such as offers, coupons, vouchers, rewards, discounts, gifts, or “buy one get one free” promotions, are effective and popular sales promotion methods for merchants to grow business. Nowadays these value added services are seen being distributed and redeemed electronically. The merchants, instead of giving their customers physical vouchers, are distributing various electronic offers, coupons, vouchers, rewards, discounts, gifts, or “buy one get one free” promotions to various customers, either existing or potential. These electronic value added services may be sent in an email, or may be sent via an application designed by the merchants (a merchant's application). The various customers may use their mobile devices, such as mobile phone, tablet, PDA, or the like, to receive and retain these electronic value added services.

To redeem the electronic value added services, customers no longer need to present a physical voucher, a print-out of the received value added service, or the like, at the counter when they decide to purchase goods or services at the merchant's store using the received electronic value added services. Instead, they normally need to open the email containing the electronic value added services, or open the application retaining the electronic value added services. These electronic value added services usually indicate effective periods and/or usernames thereon, so that the staff of the merchant's store may recognise them manually and apply the discount or give the reward in accordance with what the value added services have offered.

A more popular typical implementation is one that allows the customers to open the application and select the one or more electronic value added services that they want to use. The application then generates a one-dimensional barcode such as a classic barcode or a two-dimensional barcode such as a QR code to accompany the electronic value added service. The customers then present their mobile device to a classic barcode reader or a QR code reader at the counter of the merchant's store for scanning so that the discount or reward will be applied in accordance with what the value added services have offered. When the customers use more than one electronic value added service, they may need to scan separate codes.

After the electronic value added services are applied, either by being recognised manually or read by bar code or QR code reader at the counter, the merchant then starts a payment process to complete the purchase transaction for the goods or services.

Payment nowadays can also be made using a customer's mobile device. It can be done within one single continuous data transmission, within a few seconds, by a single action of the customer to present the customer's mobile device to a payment terminal of the merchant's counter, given that both the customer's mobile device and the merchant's payment terminal are NFC enabled.

In view of the above, it is apparent that compared to the convenience of NFC enabled mobile device payment, the redemption of value added services is rather cumbersome and requires a transaction separate from and in addition to the payment transaction. Therefore, the convenience of NFC enabled mobile payment is adversely affected when customers want to redeem one or more value added services for goods or services to be purchased.

There is thus a need to streamline the redemption of the value added service and enhance the convenience of mobile NFC payment by incorporating value added services into the payment process, such that the value added service can be automated in combination with mobile NFC payment in a one-tap settlement. In the present application, one-tap settlement is a process where data exchanged during the initiation and completion of the payment process occurs over an uninterrupted sequence. Thus, the one-tap settlement in this context is a two-way uninterrupted communication between two devices, for example, a NFC enabled mobile device and a NFC enabled payment terminal at the merchant's counter; and is performed within a single action of placing the NFC enabled mobile device in proximity to the payment terminal at the merchant's counter. Furthermore, other desirable features and characteristics will become apparent from the subsequent detailed description and the appended claims, taken in conjunction with the accompanying drawings and this background of the disclosure.

### SUMMARY

According to one aspect of the invention, there is provided a method for processing a one-tap settlement of purchase of goods or services between a NFC enabled mobile device and a NFC enabled payment machine. The processing of the one-tap settlement comprises factoring in at least one effect that redemption of one or more selected value added services has on the one-tap settlement. The method comprises pre-tap processing at the NFC enabled mobile device to load one or more selected value added services into the NFC enabled mobile device, and placing the NFC enabled mobile device in proximity to the NFC enabled payment machine so as to initiate and complete the one-tap settlement, where data is exchanged so as to process the purchase of goods or services utilizing the redeemed one or more of the selected value added services loaded during the pre-tap processing to bring about the at least one effect provided by the redemption of one or more selected value added services.

According to another aspect of the invention, there is provided a method for processing in a NFC enabled payment machine a one-tap settlement for purchase of goods or services with a NFC enabled mobile device. The processing factors in at least one effect that one or more selected value added services has on one-tap settlement. The method comprises receiving token data from the NFC enabled mobile device in response to the NFC enabled mobile device being placed in proximity to the NFC enabled payment machine. The token data comprises information on the effect redemption of the one or more selected value added services has on the one-tap settlement, wherein the token data is generated by a merchant server administering the one or more value added services. The method further comprises communicating, with the merchant server, the token data to verify the validity of the one or more selected value added services; and determining a cost of the purchased goods or services in response to an outcome of the verification of the validity of the one or more selected value added services.

According to another aspect of the invention, there is provided a merchant server for administering one or more value added services redeemed during a one-tap settlement of purchase of goods or services between a NFC enabled mobile device and a NFC enabled payment machine. The merchant server comprises at least one processor; at least one memory including computer program code; and at least one communication interface. The at least one memory and the computer program code are configured to, with at least one processor, cause the merchant server at least to:

during pre-tap processing, transmit one or more value added services to the NFC enabled mobile device, of which a selection is loaded into the NFC enabled mobile device; and

during the one-tap settlement
receive, during the one-tap settlement, token data from the NFC enabled payment machine, the token data comprising the one or more value added services selected by the NFC enabled mobile device and information on an effect redemption of the selected one or more value added services has on the one-tap settlement;
verify the validity of the one or more selected value added services; and
transmit, to the NFC enabled mobile device, an indicator of an outcome of the verification of the validity of the one or more selected value added services.

According to another aspect of the invention, there is provided a NFC enabled payment machine for processing a one-tap settlement of purchase of goods or services initiated by a NFC enabled mobile device placed in proximity to the NFC enabled payment machine. The NFC enabled payment machine comprises at least one processor; at least one memory including computer program code; and at least one communication interface. The at least one memory and the computer program code are configured to, with at least one processor, cause the NFC enabled payment machine at least to:

receive, during the one-tap settlement, token data from the NFC enabled mobile device, wherein the token data comprises information on the effect redemption of the one or more selected value added services has on the one-tap settlement, wherein the token data is generated by a merchant server administering the one or more value added services;

communicate, with the merchant server, the token data to verify the validity of the one or more selected value added services; and

determine a cost of the purchased goods or services in response to an outcome of the verification of the validity of the one or more selected value added services.

According to another aspect of the invention, there is provided a non-transitory computer readable medium having stored thereon executable instructions for controlling a computer to administer one or more value added services redeemed during a one-tap settlement of purchase of goods or services between a NFC enabled mobile device and a NFC enabled payment machine. The computer is controlled to perform steps comprising:

during pre-tap processing, transmitting one or more value added services to the NFC enabled mobile device, of which a selection is loaded into the NFC enabled mobile device; and

during the one-tap settlement
receiving, during the one-tap settlement, token data from the NFC enabled payment machine, the token data comprising the one or more value added services selected by the NFC enabled mobile device and information on an effect redemption of the selected one or more value added services has on the purchased goods or services;
verifying the validity of the one or more selected value added services; and
transmitting, to the NFC enabled mobile device, an indicator of an outcome of the verification of the validity of the one or more selected value added services.

According to yet another aspect of the invention, there is provided a non-transitory computer readable medium having stored thereon executable instructions for controlling a computer to process a one-tap settlement of purchase of goods or services initiated by a NFC enabled mobile device placed in proximity to the NFC enabled payment machine. The computer is controlled to perform steps comprising:

receiving, during the one-tap settlement, token data from the NFC enabled mobile device, wherein the token data comprises information on the effect redemption of the one or more selected value added services has on the one-tap settlement, wherein the token data is generated by a merchant server administering the one or more value added services;

communicating, with the merchant server, the token data to verify the validity of the one or more selected value added services; and

determining a cost of the purchased goods or services in response to an outcome of the verification of the validity of the one or more selected value added services.

### BRIEF DESCRIPTION OF THE DRAWINGS

Embodiments of the invention will be better understood and readily apparent to one of ordinary skilled in the art from the following written description, by way of example only, and in conjunction with the drawings, in which:

FIG. 1 shows a schematic of a prior art process for a regular value added service redemption in a goods and services purchase transaction.

FIG. 2 shows a schematic of a system in which NFC payment incorporating value added service redemption may be performed where data is exchanged over one single uninterrupted sequence.

FIG. 3A shows a schematic of data flows in a pre-tap process occurring in the system of FIG. 2, while FIG. 3B shows a schematic of data flows in a one-tap settlement occurring in the system of FIG. 2.

FIG. 4 shows an exemplary computing device to realize a merchant server and a NFC enabled payment machine in accordance with the system shown in FIG. 2.

FIG. 5 shows a flowchart depicting steps of a method performed by a NFC enabled mobile device to effect payment incorporating the redemption of value added services in a one-tap settlement.

FIG. 6 shows a flowchart depicting steps of a method performed by a NFC enabled payment machine during one-tap settlement of purchase of goods or services factoring in the redemption of one or more selected value added services.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred method.

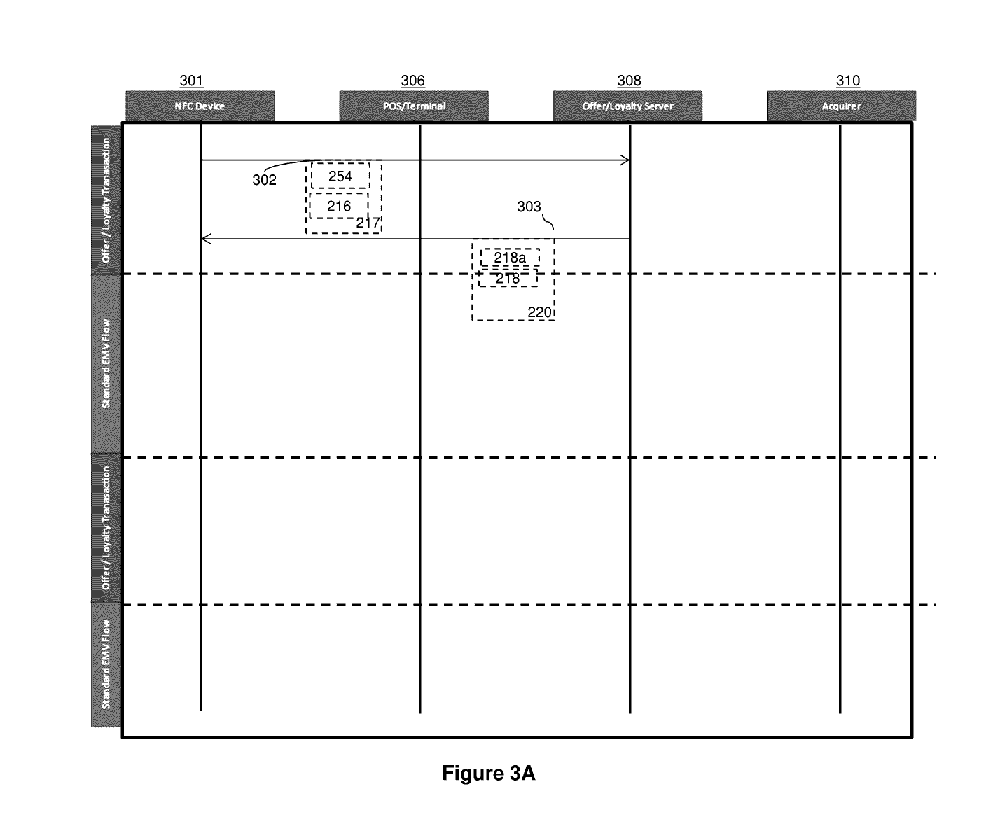

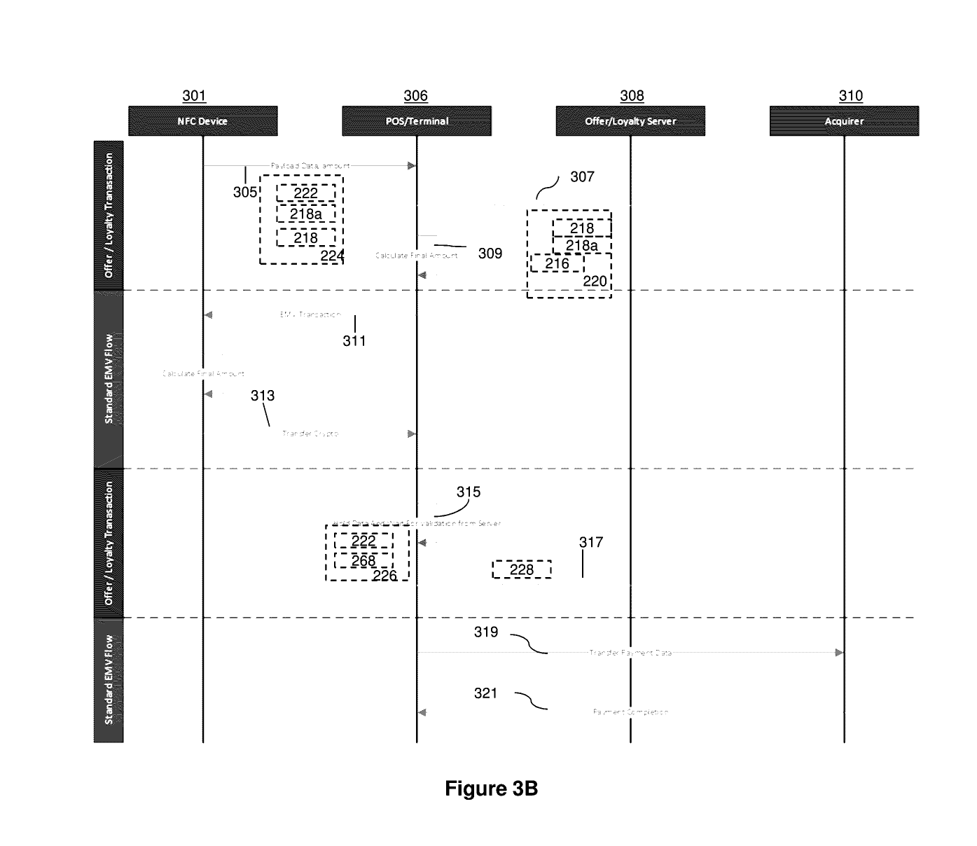

In the present application, it is appreciated by the skilled person in the art that payment machine and payment terminal are used interchangeably. The payment machine/terminal is configured for wireless communication, which may in accordance with NFC protocol. In some embodiments, the payment machine/terminal is illustrated as POS/Terminal, as illustrated in FIGS. 3A and 3B. Also, in some embodiments, merchant server can be interpreted as an offer or loyalty server, as illustrated in FIGS. 3A and 3B.

In the present application, value added services comprise various types of sales promotion methods. As a non-limiting example, the redemption of the value added services may have the effect of applying a discount on the cost of the goods or services to be purchased and/or providing rewards. The rewards may be in the form of accumulated loyalty points, vouchers, annual fee waivers, rebates on future purchases and/or a gift. The effect(s) of the value added services may be provided after a predetermined quantity of goods or services are purchased. It is understandable to the skilled person that the value added services may have other effects which are not specifically mentioned herein for the sake of simplicity.

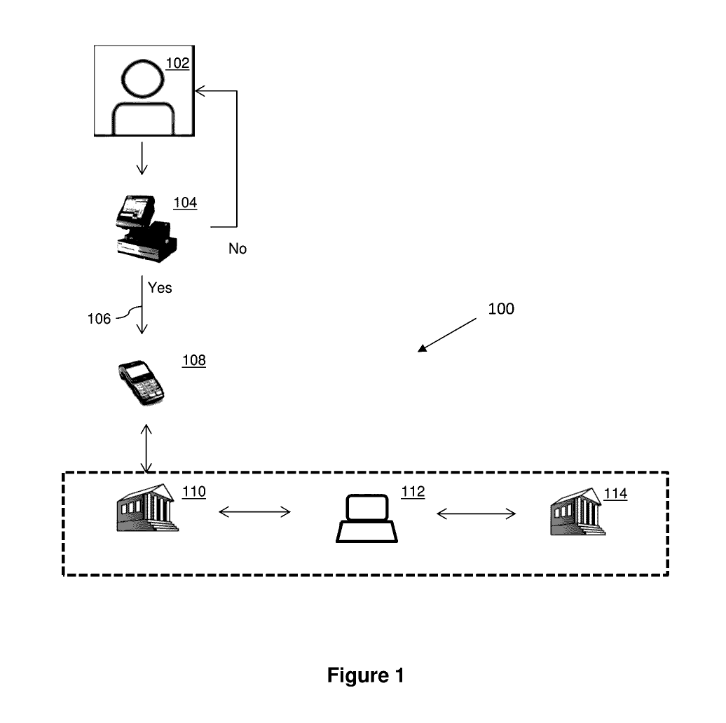

FIG. 1 shows a prior art process for a regular value added service redemption in a goods and/or services purchase transaction. As described above, a regular value added service redemption in a goods and services purchase transaction is one where the customer 102 presents one or more electronic value added services selected from those received and retained on his/her mobile device at the merchant counter 104, prior to payment of the goods and/or services to be purchased made at merchant payment machine 108.

At the counter 104, the relevant personnel checks the validity of the selected electronic value added services by manually verifying the effective periods and/or usernames indicated thereon or by scanning the barcodes comprising information of the effective periods and/or usernames shown on the customer's 102 mobile device via a classic barcode reader or a QR code reader. The barcodes may accompany the selected electronic value added services in an email or be generated by the merchant application. If the selected electronic value added services are successfully verified (the successful verification being symbolised as a “Yes” state in FIG. 1, before merchant counter 104 communicates 106 with the payment machine 108 to carry out payment), the cost deduction or rewards gained will be first calculated at the counter 104 to arrive at a final amount to pay and/or rewards to be gained. The final amount to pay will then be transmitted 106 to the payment machine 108 for payment. The selected electronic value added services are thus successfully redeemed.

On the other hand, if the selected electronic value added services cannot be successfully verified, the personnel at the counter 104 will inform the customer 102 and may check if the customer 102 has other optional electronic value added services to redeem. If other valid electronic value added services are also not available, a final amount to pay is calculated at step 106 at the counter without cost deduction or rewards to be gained.

After the final amount is calculated, a payment transaction follows at the payment machine 108. The customer 102 may use one of a variety of payment methods to complete the payment transaction. For example, the customer 102 may use cash or other financial instruments, e.g. completing an electronic transaction by swiping magnetic strip cards or inserting EMV chip cards on the merchant's payment machine 108. The cards may be debit cards, credit cards, pre-paid cards or value storage cards. Alternatively, payment may be conducted via a payment application, designed by an intermediary 112 of the financial instruments, installed on the customer's mobile device 102 where the information of the financial instruments is securely retained.

During the payment transaction at the payment machine 108, the customer 102 opens the payment application. The application may generate a classic barcode or QR code indicating the information of the financial instrument (for example, primary account number/PAN or a tokenized version thereof, expiry date, and/or other information transmissible to a payment network for processing of a transaction). The merchant's payment machine/terminal may include a classic barcode reader or a QR code reader to process the information of the financial instrument shown on the payment application on the customer's mobile device.

In another example, during the payment transaction, the customer 102 opens the payment application on his/her mobile device which is NFC enabled. The payment transaction is simpler and more efficient in this case, as no barcode reader is needed at the merchant's counter, as long as the merchant's payment machine/terminal 108 is also NFC enabled. The customer 102 presents his/her mobile device having the payment application initialised to communicate with the NFC enabled payment terminal 108, so that the information of the financial instrument can be readily processed without optical scanning (which can be cumbersome), and even without physical contact with the NFC enabled payment terminal.

The processed information of the financial instrument is then sent by the payment terminal 108 to an acquirer 110 of the merchant for account authentication. The acquirer 110 conducts the account authentication by forwarding the processed information to the intermediary 112 for checking with an issuer 114 of the financial instrument. After the financial instrument is successfully authenticated, the payment transaction is done. A receipt of the goods or services purchased with the redemption of the value added services shown is then provided to the customer. The receipt may be printed out on paper or electronically shown in the payment application.

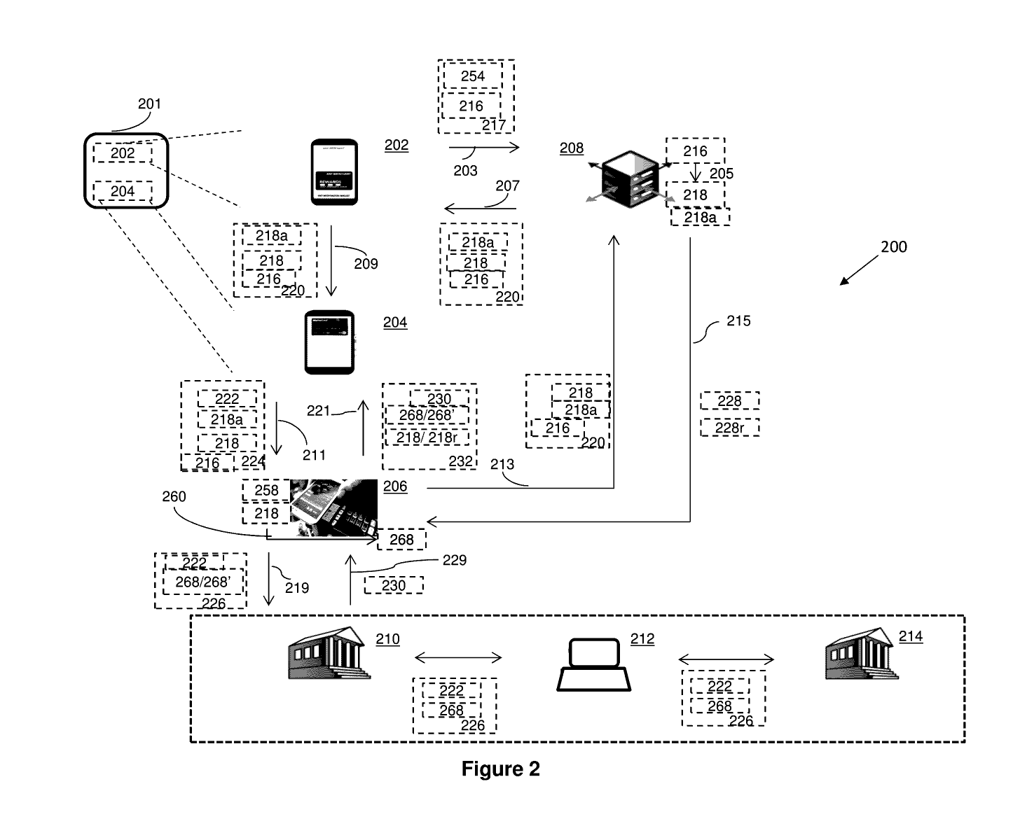

FIG. 2 shows a schematic of a system 200 in which NFC payment incorporating value added service redemption is performed. Such NFC payment is performed through a one-tap settlement, which sees data exchange to allow mobile NFC payment and value added service redemption to occur over an uninterrupted sequence. In such a sequence, data exchange that a merchant application uses to process the redemption of value added services and a payment application uses to process payment of purchased goods and/or services, which factors in the effect that the redemption of the value added services has on the purchase, is uninterrupted from the point a transaction (which requires the execution of this data exchange) is initiated to the point this transaction is completed. A continuous exchange of data thus occurs for such a transaction for purchase of goods that factor in the effect that the redemption of one or more value added services has on the purchase. Such an uninterrupted data exchange sequence is in contrast to a process (not shown) supporting a similar transaction, where a merchant application is initiated to perform a data exchange to process the exchange of data that facilitates the redemption of the value added services, which is then interrupted by the initiation of a payment application to perform a data exchange to process payment

The system 200 involves similar participants to those described in FIG. 1, so that the system 200 includes a customer's NFC enabled mobile device 201 which may have a merchant application 202 installed, and which may also have a payment application 204, designed by an intermediary 212, installed thereon. In some embodiments, the payment application 204 may be integrated into the merchant application 202. The system 200 further includes a NFC enabled payment machine/terminal 206 that can conduct data exchange with the NFC enabled mobile device 201 and the application 204 without physical contact, as long as both are within NFC radio frequency (RF) field communication range, such as 10 cm or less. Furthermore, the system includes a server 208 with which the merchant application 202 communicates.

Similar to the system 100 as shown in FIG. 1, the system 200 also comprises an acquirer 210, an intermediary 212 and an issuer 214. The acquirer 210 is a participant that seeks authorization from the issuer 214 via the intermediary 212 on whether the customer meets the criteria that allows for the customer to use the infrastructure provided by the financial services provider to which the intermediary 212 belongs. The acquirer 210 pays the transaction that the customer makes with the merchant after the transaction is approved. The acquirer 210 may include any one or more of a bank or other financial institution, or a telecommunication service provider.

As described above, the issuer 214 provides payment instruments, such as a credit or a debit card, for holders (i.e. the customer) of such instruments to make purchases from the merchant. The issuer 214 typically provides the owner of such payment instruments a credit line (especially in the case of the credit card) against which is checked whether there are sufficient funds to pay for a transaction initiated by the holder of a payment instrument. In this context, the issuer 214 can be understood to be the bank of the customer. In the following description, the customer and the holder are used interchangeably.

It is appreciated that, for simplicity, the interactions depicted in the present description between the acquirer 210, the intermediary 212 and an issuer 214 for authorization are streamlined, so that the detailed description hereinafter focuses on processing the transaction for purchase of goods or services, wherein the processing factors in the effect that one or more selected value added services has on the transaction.

In the present embodiment as shown in the example of FIG. 2, one or more value added services are provided to the customer via the merchant application 202. These value added services may be provided to the merchant application 202 by the merchant server 208 periodically or dynamically based on the geographic information on the mobile device 201. For example, the merchant server 208 may use an external party (such as an internet service provider) to push advertisements inviting for the value added service to be downloaded into the NFC enabled mobile device 201 if the NFC enabled mobile device 201 is not in sufficient proximity to the merchant server 208 for the merchant server to directly send such advertisements. The external party may push the advertisements in accordance with a pre-determined schedule. In cases where the NFC enabled mobile device 201 is in sufficient proximity to the merchant server 208, for example through the merchant server 208 detecting that the NFC enabled mobile device 201 is in the vicinity based on geographic information collected by the merchant application 202, the merchant server 208 can then push value added services to the NFC enabled mobile device 201 dynamically. In the merchant store, if the customer decides to use the value added services, he/she may use his/her NFC enabled mobile device 201 to initialize the merchant application 202 installed thereon. If registration is required, the merchant application 202 may have been registered prior to being initialized in the present embodiment.

In the present embodiment, a pre-tap process (symbolised by reference numeral 203 to represent data flow initiated by the merchant application 202 to the merchant server 208 and data received 207 by the merchant application 202 from the merchant server 208), is conducted. In the pre-tap process, the customer may select one or more value added services that he/she decides to redeem present on the merchant application 202 in the NFC enabled mobile device 202. The skilled person in the art would appreciate that the pre-tap process may be conducted any time before presenting the NFC enabled mobile device 201 in proximity to the NFC enabled payment machine 206. It will be appreciated that the pre-tap process can be done before the customer enters the merchant store, or it can also be done swiftly in a few seconds before placing the NFC enabled mobile device 201 in proximity to the NFC enabled payment machine 206 for one-tap settlement.

One or more of the value added services may also be redeemable only against a specific good or service, i.e. it has to be determined whether a value added service is meant to be redeemed against a purchased good or service. The merchant application 202 is configured to compare the selected one or more value added services against the goods or services to be purchased, identify whether the selected one or more value added services is intended for the goods or services, and then determine the effect the value added service has on the purchase of the good or service if the merchant application 202 determines that the value added service is meant for use on the good or service.

As the one or more value added services are selected for redemption, the merchant application 202 is configured to communicate 203 with the merchant server 208. Preferably, the merchant server 208 may be a backend server 208 to administer value added service for the merchant application 202, either belonging to the merchant or belonging to a third party managing the value added services for the merchant. The merchant application 202 is configured to send a data package 217 that includes information 216 on the one or more selected value added services and/or the customer's registration details 254, to the merchant server 208. The data packet 217 may be generated locally on the NFC enabled mobile device 201 in case of non-availability of Internet connection.

Upon receipt of the data package 217, the merchant server 208 verifies the customer's registration details 254. If the customer's registration details 254 are valid, the merchant server 208 determines 205 from the one or more selected value added services 216 data 218 that provides information on what effect or effects the redemption will have on the one-tap settlement (for example, on the price of the goods or services, or on a reward quantum which is based on the price of the goods or services). In the present embodiment, the merchant server 208 may also generate and store a unique token 218a to identify the usage status of the one or more selected value added services 216. For example, where the one or more selected value added services is successfully verified at the server 208, the unique token 218a reflects the status that these value added services are valid and redeemable. In contradistinction, should one or more of the selected value added services be consider invalid, such as having exceeded a maximum number of times the selected value added service can be redeemed or the value added service has already expired, the status of the unique token 218a is also updated accordingly. It will be appreciated to the skilled person in the art that the unique token 218a may reflect other statuses which are not specifically mentioned herein for the sake of simplicity. In the case where the unique token 218a reflects the status that these value added services have already been used, repetitive attempts to redeem these value added services will be void as the merchant server 208, when processing these value added services, will recognise based on the unique token 218a that such value added services have already been redeemed. The data 218 providing information on the effect that the selected one or more value added services has is then sent back 207 to the merchant application 202 in the customer's NFC enabled mobile device 201 within token data 220. The token data 220 comprises information on the effect redemption of the one or more selected value added services has on the one-tap settlement for the purchase of the goods or services. Such information may include the unique token 218a data and data detailing the effect or effects the one or more selected value added services has on the one-tap settlement. The token data 220 may also include the one or more selected value added services 216.

The token data 220, generated by the merchant server 208 in response to the one or more selected value added services, includes the one or more selected value added services 216, the unique token 218a and the data 218 of the effect(s) that the selected one or more value added services has on one-tap settlement. This token data 220 is forwarded to the payment application 204 installed in the NFC enabled mobile device 201. The payment application 204 may be initialized either before or after the initiation of the merchant's application 202. In some embodiments, the payment application 204 may be integrated into the merchant's application 202 so that it can be initialized at an interface of the merchant's application 202. The payment application 204 may be implemented as a service which runs in the background while the merchant application 202 is executing, or may provide a set of application program interface (API) functions which can be invoked by the merchant application 202, for example.

It can be appreciated by the skilled person in the art that the above data transmission between the customer's NFC enabled mobile device 201 and the server 208 may be realised by Wi-Fi connection or cellular communication, for example. This data transmission is undertaken in the pre-tap process, resulting in loading the token data 220 of the one or more selected value added services 216 into the NFC enabled mobile device 201. It is appreciable to the skilled person in the art that the pre-tap process may be performed immediately before placing the customer's NFC enabled mobile device 201 into proximity to the merchant's payment machine 206 for the one-tap settlement. After the token data 220 is received 207 by the customer's mobile device 201 via the merchant application 202 from the merchant server 208, the merchant application 202 loads 209 the token data 220 to the initialized payment application 204 within the customer's mobile device 201.

In the present embodiment, the payment application 204 on the customer's mobile device 201 is configured to communicate via NFC connection with the merchant payment machine 206. Also, in the present embodiment, the merchant payment machine 206 is NFC enabled. For example, the merchant payment terminal 206 may be a contactless reader device having the MasterCard Contactless Reader 3.0 (MCL 3.0) kernel, or a functional equivalent, executed thereon. Therefore, when the mobile device 201 having the payment application 204 initialized is placed within a pre-determined distance of the payment machine 206, i.e. in proximity of the payment machine 206, the above mentioned one-tap settlement is initiated and established by an sequence of uninterrupted continuous data exchange (symbolised by reference numeral 211 to represent data flow initiated by the customer's mobile device 202 to the payment machine 206 and reference numeral 221 to represent data flow received by the NFC enabled mobile device 201 from the payment machine 206) between the customer's mobile device 201 and the payment machine 206 via a NFC connection.

In the one-tap settlement process, the payment application 204 transmits 211 a data package 224 from the NFC enabled mobile device 201 to the NFC enabled payment machine 206. The data package 224 comprises credentials 222 of the payment instrument registered in the payment application 204 and the token data 220 that includes the one or more selected value added services 216, the unique token 218a and data 218 providing information on the effect that the selected one or more value added services has on the one-tap settlement.

The NFC enabled payment machine 206, upon receipt of the data package 224, retains the data 218 providing information on the effect that one or more selected value added services has on the one-tap settlement and transmits 213 the token data 220 that includes the one or more selected value added services 216, the unique token 218a and data 218 providing information on the effect that the selected one or more value added services has on the one-tap settlement to the server 208 to verify the validity of the one or more selected value added services 216. In some embodiments, the verification is conducted on a value added service database at the merchant server 208.

Simultaneously as the verification is being carried out, the NFC enabled payment machine 206 determines 260 the effect 218 that the selected one or more value added services has on the one-tap settlement in view of purchase data 258 collected at the NFC payment machine 206. The purchase data 258 may include details of the goods and/or services to be purchased. Thus, while the merchant server 208 is verifying the validity of the token data 220, the NFC enabled payment machine determines the effect that the redemption of the selected one or more value added services has 218 on the transaction with a cost 268 of the purchased goods and/or services in the one-tap settlement with the one or more selected value added services redeemed. The cost 268 of the purchased goods and/or services results from modification due to the redemption of the one or more selected value added services whose validity is being verified. The NFC payment machine 206 communicates the cost 268 to the NFC enabled mobile device 201 for the customer's authorization of the transaction. In response, the NFC enabled mobile device 201 sends back authorization data to the NFC enabled payment machine 206 if the customer gives consent. For the sake of simplicity, the communication between the NFC payment machine 206 and the NFC enabled mobile device for the customer's authorization of the cost 268 for the goods and/or services purchased in the present transaction with the value added services redeemed is not depicted in FIG. 2. However, this communication is illustrated as steps 311 and 313 in FIG. 3B and described below.

It is appreciable to the skilled person in the art that the above described one-tap settlement which incorporates NFC mobile payment with automatic value added service redemption significantly reduces transaction time compared to conventional purchase transactions, comprised of separated value added service redemption and payment transaction, as described in FIG. 1. In the present embodiment, the one-tap settlement incorporating the automatic redemption of the one or more selected value added services may last for only a few seconds.

If the authorization of the customer's consent to the cost 268 completes before the verification of the one or more selected value added services, the NFC payment machine 206 may, during the interim, hold a data package 226 including information on the cost 268 to which the customer has consented and the credentials 222 of the payment instrument registered in the payment application 202 and wait for an outcome 228, 228r of the verification sent 215 from the server 208. After the verification is completed, the merchant server 208 provides the outcome of the verification of the validity of the one or more selected value added services to the payment machine 206. The outcome may indicate that the selected one or more value added services are successfully verified or unsuccessfully verified. If one or more of the selected value added services is successfully verified, an indicator 228 of the one or more validly verified one or more of the selected value added services may be transmitted from the merchant server 208 to the payment machine 206.

On the other hand, if the one or more selected value added services 216 are unsuccessfully verified, a void symbol 228r may be transmitted from the merchant server 208 to the payment machine 206. Upon receipt of the void symbol 228r, the payment machine 206 will revoke the modification derived by utilising the redeemed one or more selected value added services which resulted in the cost 268. If only one of the one or more selected value added services is unsuccessfully verified, the payment machine 206 will only revoke the modification to undo the one unsuccessfully verified value added service. It is appreciable to the skilled person in the art that the revocation of the modification derived from redeeming the one or more selected value added services varies accordingly in view of the effect that the redemption of unsuccessful verification has on the one-tap settlement. For example, the unsuccessfully verified value added service at the payment machine 206 may lead to a revoked discount on the cost 268 of the purchased goods and/or services, or may lead to a withdrawal of a gift to be awarded, etc. . . . . As a consequence of the unsuccessfully verified value added services, an adjusted cost 268′ will be determined at the payment machine 206. In the cases where none of the one or more value added services are unsuccessfully verified, the payment machine 206 will generate a negative indicator 218r, and the adjusted cost 268′ may be reverted to the original cost of the purchased goods and/or services before redemption of any selected value added services. For the simplicity of the description, the determination steps of the adjusted cost 268′ and the negative indicator 218r are not depicted in the present application. It is appreciable to the skilled person in the art that the negative indicator 218r may be the void symbol 228r generated by the merchant server 208 and transmitted 215 to the payment machine 206.

In the cases where the one or more selected value added services are successfully verified, the payment machine 206 subsequently sends the data package 226 that includes the cost 268 utilising the redeemed one or more selected value added services and the credentials 222 of the payment instrument for authorization of payment 219. As described herein, for simplicity, the authorization of payment will not be described in great detail. It is appreciated to the skilled person that the authorization of payment involves the acquirer 210, the intermediary 212 and the issuer 214. In the present embodiment, the data package 226 including the credentials 222 of the payment instrument issued by the issuer 214 and registered in the payment application 204 provided by the intermediary 212, and the cost 268 utilising the redeemed one or more selected value added services, is authorised during the authorization of payment (symbolised by reference numeral 219 to represent data flow initiated by the NFC enabled payment machine 206 to acquirer 210 and reference numeral 229 to represent data flow received by the NFC enabled payment machine 206 from the acquirer 210.

Upon successful completion of the authorization of payment, an authorization outcome 230 is provided to the payment machine 206. In the present embodiment, the NFC payment of goods or services incorporating value added service redemption is then fulfilled within one uninterrupted continuous data exchange represented by data flows 211 and 221 between the customer's NFC enabled mobile device 201 and the merchant's NFC enabled payment machine 206. The data flow 221 is initiated by the NFC enabled payment machine 206 to transmit 221 an indicator 232 to the NFC enabled mobile device 201 in response to the outcome 228, 228r of the verification of the validity of the one or more selected value added services. In the embodiment illustrated in FIG. 2, when the one or more selected value added services are successfully verified as described above, the indicator 232 includes detail on the manner in which the cost 268 of the purchased goods or services is modified in response to the successfully redeemed one or more selected value added services. In the present embodiment, the indicator 232 comprises the authorization outcome 230, the cost 268 for the goods and/or services purchased in the present one-tap settlement with the value added services automatically redeemed, and the effect 218 that the selected one or more value added services has on the one-tap settlement. Where the one or more selected value added services is not successfully verified, the cost 268 is replaced by the adjusted cost 268′ in the indicator 232 transmitted 221 from the NFC enabled payment machine 206 to the NFC enabled mobile device 201. In such a case, the effect 218 that the selected one or more value added services has on the one-tap settlement is replaced by the negative indicator 218r in the indicator 232.

It is appreciated to the skilled person that the effect that the selected one or more value added services provides 218 may be a discount on the cost, or a reward of the goods or services to be purchased. The effect may also be in the form of rewards. The rewards may be in the form of accumulated loyalty points, vouchers, annual fee waivers, rebates on future purchases and/or a gift. The effect that the selected one or more value added services provides 218 may be provided after a predetermined quantity of goods or services are purchased.

As depicted in the example of FIG. 2, when the authorization of payment 219 is sought, the data package 226 comprising information on the cost 268 or the adjusted cost 268′ of the purchased goods or services and the credentials 222 of the payment instrument issued by the issuer 214 is forwarded to a server (not shown) of the acquirer 210.

FIG. 3A depicts data flows 302, 303 in a pre-tap process. The data flow 302 corresponds to data flow 203 of FIG. 2, wherein the NFC enabled mobile device 301 selects one or more value added services 216 present in the NFC enabled mobile device 301 used to perform the one-tap settlement. The data package 217 transmitted in the data flow 302 comprises information on the selection of one or more value added services 216 and/or the customer's registration details 254. The data flow 303 corresponds to data flow 207 of FIG. 2, wherein the merchant server 308 generates token data 220 in response to the selection of the one or more value added services 216 and sends the token data 220 back to the NFC enabled mobile device 301. The token data 220 comprises the one or more selected value added services 216 and information on the effect the redemption of the one or more selected value added services 216 have on the one-tap settlement for the purchase of the goods or services. Such information, on the effect the redemption of the one or more selected value added services 216 has on the one-tap settlement for the purchase of the goods or services, found in the token data 220 includes the unique token 218a and the data 218 of the effect or effects the selected one or more value added services 216 have on the one-tap settlement.

FIG. 3B depicts data flows 305, 307, 309, 311, 313, 315, 317, 319 and 321 in a one-tap settlement. The data flow 305 corresponds to data flow 211 of FIG. 2, wherein the NFC enabled mobile device 301 transmits a data package 224 to the NFC enabled payment machine 306. The data package 224 comprises credentials 222 of the payment instrument registered in the payment application 204 and the token data 220 that includes the one or more selected value added services 216, the unique token 218a and the data 218 providing information on the effect that the selected one or more value added services has on the goods or services to be purchased. The data flow 307 corresponds to data flow 213 of FIG. 2, wherein the NFC enabled payment machine 301 forwards the token data 220 that includes the one or more selected value added services 216, the unique token 218a and the data 218 providing information on the effect that the one or more selected value added services have on the one-tap settlement of the goods or services to be purchased to the server 308 to verify the validity of the selected one or more value added services. The data flow 309 corresponds to data flow 260 of FIG. 2, wherein the NFC enabled payment machine 306 determines 205 the effect 218 that the selected one or more value added services has on the one-tap settlement in view of purchase data 258 collected at the NFC payment machine 306. The purchase data 258 may include details of the goods and/or services to be purchased. The data flows 311 and 313 were omitted in FIG. 2 for simplicity purposes. The data flows 311 and 313 represent steps where the NFC enabled payment machines 306 communicates with the NFC enabled mobile device 301 to seek customer's consent to the cost 268. These data flows 311 and 313 take place simultaneously during the merchant server 308 verifying the validity of the one or more selected value added services.

The data flow 315 refers to the interim when the customer's consent to the cost 268 is obtained before the verification at the merchant server 308 completes, the NFC enabled payment machine 306 is awaiting the outcome 228, 228r from the merchant server 308 while holding the data package 226 including the credentials 222 of the payment instrument issued by the issuer 214 and the effect the selected one or more value added services 216 has, e.g. a discounted cost, on the one-tap settlement of the goods or services to be purchased, At the data flow 317, which corresponds to data flow 215 of FIG. 2, the merchant server 308 forwards the outcome 228 of the verification of the validity of the one or more selected value added services to the payment machine 306. It can be seen from FIG. 3B that the illustrated example only represents the scenario where all the one or more selected value added services 216 are successfully verified. Therefore, the NFC enabled payment machine 306, upon receipt of the successful outcome 228, transmits in data flow 319 the data package 226 that comprises the cost 268 having obtained the customer's consent and the credentials 222 of the payment instrument issued by the issuer 214 authorization of payment to the acquirer 310. The authorization process at the acquirer is not described in the present application for the sake of simplicity.

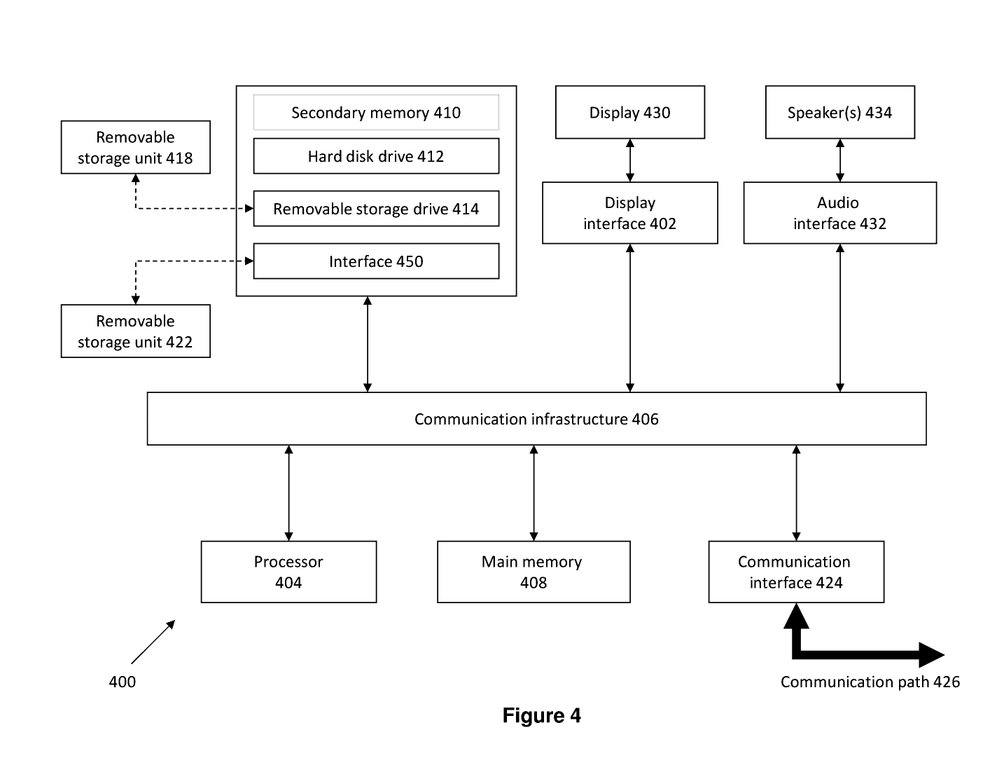

FIG. 4 depicts an exemplary computing device 400, hereinafter interchangeably referred to as a computer system 400, where one or more such computing devices 400 may be used to execute the above-described method for realising mobile NFC payments that incorporate value added service redemption within one uninterrupted continuous data transmission. The exemplary computing device 400 in accordance with the present embodiment can be the merchant server 208 or the customer's NFC enabled mobile device 201, or the merchant's NFC enabled payment machine 206. The following description of the computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a storage drive 412, which may be a hard disk drive, a solid state drive or a hybrid drive and/or a removable storage drive 414, which may include a magnetic tape drive, an optical disk drive, a solid state storage drive (such as a USB flash drive, a flash memory device, a solid state drive or a memory card), or the like. The removable storage drive 414 reads from and/or writes to a removable storage medium 444 in a well-known manner. The removable storage medium 444 may include magnetic tape, optical disk, non-volatile memory storage medium, or the like, which is read by and written to by removable storage drive 414. As will be appreciated by persons skilled in the relevant art(s), the removable storage medium 444 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 430. Examples of a removable storage unit 422 and interface 430 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 422 and interfaces 430 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments of the inventions, the communication interface 424 permits data to be transferred between the computing device 400 and a data communication network, such as a public data or private data communication network. The communication interface 424 may be used to exchange data between different computing devices 400 which such computing devices 400 form part an interconnected computer network. Examples of a communication interface 424 can include a modem, a network interface (such as an Ethernet card), a communication port (such as a serial, parallel, printer, GPIB, IEEE 1394, RJ45, USB), an antenna with associated circuitry and the like. The communication interface 424 may be wired or may be wireless. Software and data transferred via the communication interface 424 are in the form of signals which can be electronic, electromagnetic, optical or other signals capable of being received by communication interface 424. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 434.

As used herein, the term “computer program product” may refer, in part, to removable storage medium 444, removable storage unit 422, a hard disk installed in storage drive 412, or a carrier wave carrying software over communication path 426 (wireless link or cable) to communication interface 424. Computer readable storage media refers to any non-transitory, non-volatile tangible storage medium that provides recorded instructions and/or data to the computing device 400 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites and the like.

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the storage drive 412, or the interface 450. Alternatively, the computer program product may be downloaded to the computer system 400 over the communications path 426. The software, when executed by the processor 404, causes the computing device 400 to perform functions of embodiments described herein.

It is to be understood that the embodiment of FIG. 4 is presented merely by way of example to explain the operation and structure of the merchant server 208 or the NFC enabled mobile device 201, or the merchant NFC enabled payment machine 206. Therefore, in some embodiments one or more features of the computing device 400 may be omitted. Also, in some embodiments, one or more features of the computing device 400 may be combined together. Additionally, in some embodiments, one or more features of the computing device 400 may be split into one or more component parts.

In one embodiment, the computing device 400 is implemented as the merchant server 208. The computing device 400 is configured for administering one or more value added services redeemed during a one-tap settlement of purchase of goods or services between the NFC enabled mobile device 201 and the NFC enabled payment machine 206. The merchant server 208 comprises at least one processor 404, at least one memory 408, 410 including computer program code, in the form of executable instructions stored on non-transitory computer readable medium (such as removable storage units 418, 422 and the storage drive 412), and at least one communication interface 424. The at least one memory 408/410 and the computer program code are configured to, with at least one processor 404, cause the merchant server 208 at least to perform the following actions.

During pre-tap processing, the merchant server 208 transmits one or more value added services 216 to the NFC enabled mobile device 201, of which a selection is loaded into the NFC enabled mobile device 201.

In the present embodiment, during the pre-tap processing, the at least one processor 404 is further configured to cause the merchant server 208 to generate the token data 202 in response to receiving the one or more selected value added services 216. The token data 220 comprises information on the effect redemption of the selected one or more value added services 216 has on the one-tap settlement. Such information comprises the unique token 218a and the data 218 of the effect or effects the one or more selected value added services have on the one-tap settlement. The merchant server 208 then transmits the token data to the NFC enabled mobile device 201.

During the one-tap settlement, the merchant server 208 receives, during the one-tap settlement, the token data 220 from the NFC enabled payment machine 206. The token data 220 comprises the one or more value added services 216 selected by the NFC enabled mobile device 201 and information on an effect redemption of the selected one or more value added services has on the one-tap settlement. Upon receipt of the token data 220, the merchant server 208 verifies the validity of the one or more selected value added services; and transmits, to the NFC enabled mobile device 201, an indicator 228, 228r of an outcome of the verification of the validity of the one or more selected value added services.

In another embodiment, the computing device 400 is implemented as the NFC enabled payment machine 206. The computing device is configured to process the one-tap settlement of purchase of goods or services initiated by the NFC enabled mobile device 201 placed in proximity to the NFC enabled payment machine 206. The NFC enabled payment machine 206 comprises at least one processor 404, at least one memory 408, 410 including computer program code, in the form of executable instructions stored on non-transitory computer readable medium (such as removable storage units 418, 422 and the storage drive 412), and at least one communication interface 424. The at least one memory 408, 410 and the computer program code are configured to, with at least one processor 404, cause the NFC enabled payment machine 406 at least to receive, during the one-tap settlement, token data 220 from the NFC enabled mobile device 201. The token data 220 comprises information on the effect redemption of the one or more selected value added services has on the one-tap settlement, and is generated by the merchant server 208 administering the one or more value added services 216. The NFC enabled payment machine 406 is further caused to communicate, with the merchant server 208, the token data 220 to verify the validity of the one or more selected value added services 216; and determine 260 a cost 268, 268′ of the purchased goods or services in response to an outcome 228, 228r of the verification of the validity of the one or more selected value added services 216.

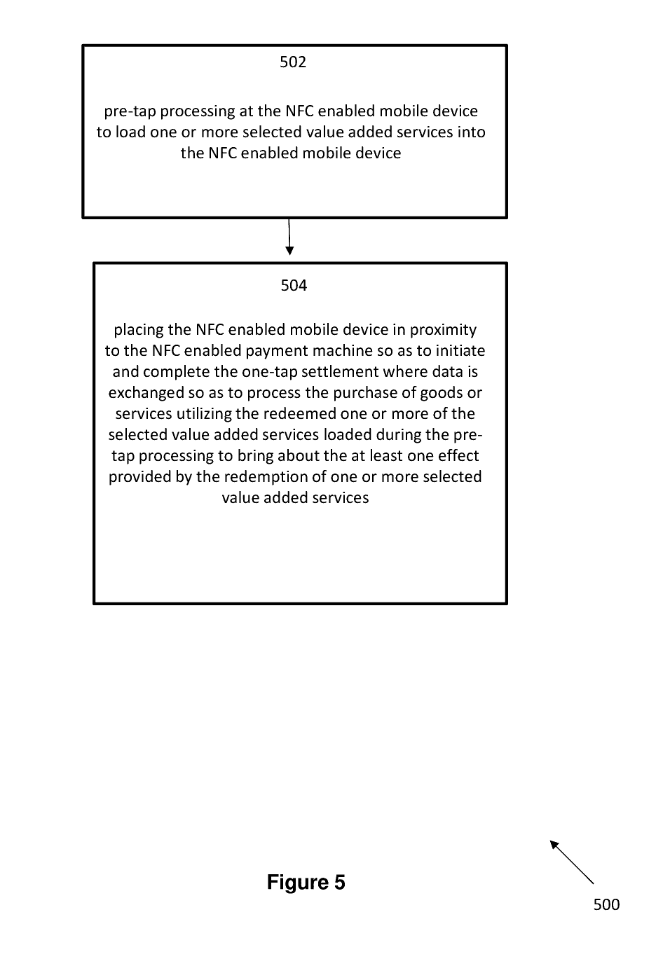

FIG. 5 shows a flowchart depicting steps of a method that allows NFC enabled mobile payment enabling automatic value added services within an uninterrupted continuous data exchange.

With reference to FIG. 4, the method according to the flow chart shown in FIG. 5 may be implemented as software and stored in a non-transitory fashion in the secondary memory 410 or the removable storage units 418, 422 of the computing device 400. The software is executable by the processor 404 of the computing device 400. The software is stored in the main memory 408 and/or the secondary memory 410 of the merchant server 208 or the customer's NFC enabled mobile device 201, or the merchant NFC enabled payment machine 206. The method allows for NFC enabled mobile payment incorporating automatic value added services in a one-tap settlement. The method includes the following steps as detailed below and described with reference to FIGS. 2, 3A and 3B.

The method as depicted in FIG. 5 is for processing a one-tap settlement of purchase of goods or services between the NFC enabled mobile device 201 and the NFC enabled payment machine 206, the processing of the one-tap settlement comprising factoring in at least one effect that redemption of one or more selected value added services 216 has on the one-tap settlement of the purchased goods or services.

At step 502, a pre-tap processing is conducted, as illustrated in FIG. 3A, at the NFC enabled mobile device to load one or more selected value added services 216 into the NFC enabled mobile device 201.

At step 504, the NFC enabled mobile device 201 is placed in proximity to the NFC enabled payment machine 206 so as to initiate and complete the one-tap settlement where data is exchanged so as to process the purchase of goods or services utilizing the redeemed one or more of the selected value added services. The one or more of the selected value added services 216 are loaded during the pre-tap processing to bring about the at least one effect 218 provided by the redemption of one or more selected value added services.

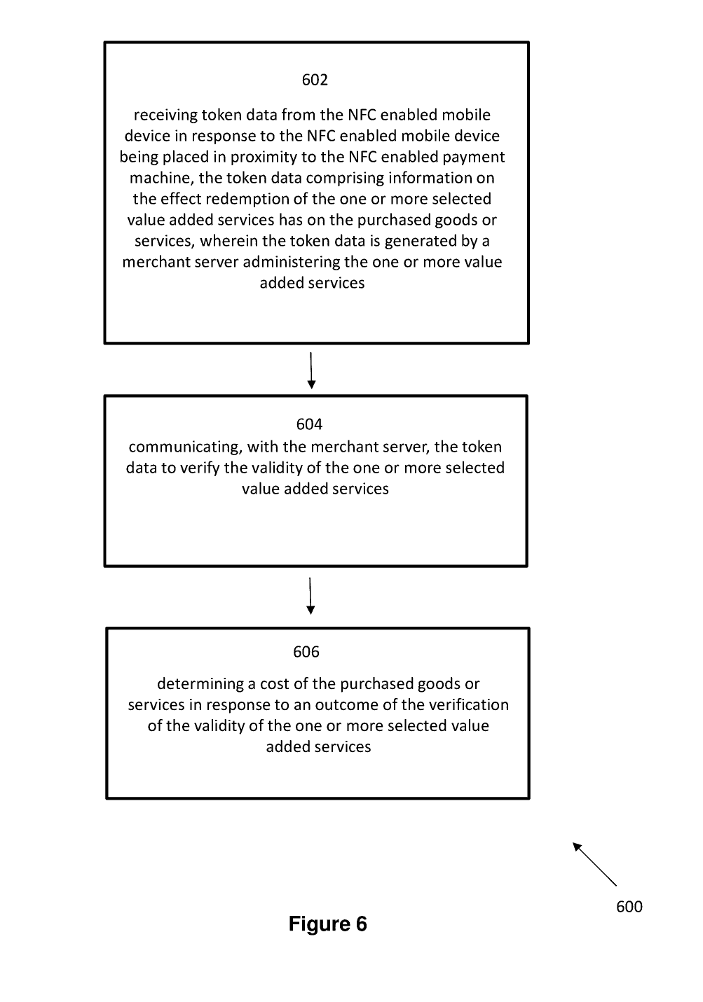

With reference to FIG. 4, the method according to the flow chart shown in FIG. 6 may be implemented as software and stored in a non-transitory fashion in the secondary memory 410 or the removable storage units 418, 422 of the computing device 400. The software is executable by the processor 404 of the computing device 400. The software is stored in the main memory 408 and/or the secondary memory 410 of the merchant's NFC enabled payment machine 206. The method allows for NFC enabled mobile payment incorporating automatic value added services in a one-tap settlement. The method includes the following steps as detailed below and described with reference to FIGS. 2, 3A and 3B.

The method as depicted in FIG. 6 is for processing in the NFC enabled payment machine 206 the one-tap settlement as described herein for purchase of goods or services with the NFC enabled mobile device 201, the processing factoring in at least one effect that one or more selected value added services has on the one-tap settlement.

At step 602, the NFC enabled payment machine 206 receives token data 220 from the NFC enabled mobile device 201. This receiving action is the NFC enabled payment machine 206 in response to the NFC enabled mobile device 201 being placed in proximity to the NFC enabled payment machine 206. The token data 220 comprises information on the effect 218 redemption of the one or more selected value added services has on the one-tap settlement. The token data 220 is generated by the merchant server 206 which administers the one or more value added services 216.

At step 604, the NFC enabled payment machine 206 communicates with the merchant server 206. In the communication, the NFC enabled payment machine 206 transmits the token data 220 to the merchant server 206 to verify the validity of the one or more selected value added services 216.

At step 606, the NFC enabled payment machine 206 determines a cost 268, 268′ of the purchased goods or services in response to an outcome 228, 228r of the verification of the validity of the one or more selected value added services.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects illustrative and not restrictive.

1. A method for processing a one-tap settlement of purchase of goods or services between a NFC enabled mobile device and a NFC enabled payment machine, the processing of the one-tap settlement comprising factoring in at least one effect that redemption of one or more selected value added services has on the one-tap settlement, the method comprising:
pre-tap processing at the NFC enabled mobile device to load one or more selected value added services into the NFC enabled mobile device; and
placing the NFC enabled mobile device in proximity to the NFC enabled payment machine so as to initiate and complete the one-tap settlement where data is exchanged so as to process the purchase of goods or services utilizing the redeemed one or more of the selected value added services loaded during the pre-tap processing to bring about the at least one effect provided by the redemption of one or more selected value added services.

2. The method in accordance with claim 1, wherein the pre-tap processing comprises:
selecting the one or more selected value added services from one or more value added services present in the NFC enabled mobile device used to perform the one-tap transaction; and
receiving, in the NFC enabled mobile device, token data comprising information on an effect redemption of the selected one or more value added services has on the one-tap settlement, wherein the token data is generated by a merchant server in response to the selection of the one or more selected value added services, wherein the merchant server administers the one or more value added services.

3. The method in accordance with claim 2, wherein the one-tap settlement comprises:
transmitting the token data from the NFC enabled mobile device to the NFC enabled payment machine;
verifying, at the merchant server, the validity of the one or more selected value added services loaded during the pre-tap processing from the NFC enabled payment machine communicating the token data with the merchant server, and
determining, at the NFC enabled payment machine, a cost of the purchased goods or services in response to an outcome of the verification of the validity of the one or more selected value added services.

4. The method in accordance with claim 1, wherein the effect that the one or more selected value added services provides comprises a discount on the cost of the purchased goods or services.

5. The method in accordance with claim 1, wherein the effect that the one or more selected value added services provides comprises rewards.

6. The method in accordance with claim 5, wherein the rewards are in the form of accumulated loyalty points, vouchers, annual fee waivers, rebates on future purchases and/or a gift.

7. The method in accordance with claim 1, wherein the effect is provided after a predetermined quantity of goods or services are purchased.

8. The method in accordance with claim 3, wherein the cost of the purchased goods or services results from modification due to the redemption of the one or more selected value added services whose validity are successfully verified.

9. The method in accordance with claim 8, wherein successful verification of the validity of the one or more selected value added services further comprises transmitting, from the NFC enabled payment machine to the NFC enabled mobile device, detail on the manner in which the cost of the purchased goods or services is modified in response to the successfully redeemed one or more selected value added services.

10. The method in accordance with claim 3, wherein unsuccessful verification of the validity of the one or more selected value added services further comprises transmitting, from the NFC enabled payment machine to the NFC enabled mobile device, a negative indicator.

11. The method in accordance with claim 3, further comprising forwarding, from the NFC enabled payment machine, the cost of the purchased goods or services to an acquirer server seeking authorization of payment.

12. The method in accordance with claim 1, wherein data exchanged during the initiation and completion of the one-tap settlement occurs over an uninterrupted sequence.

13. A method for processing in a NFC enabled payment machine a one-tap settlement for purchase of goods or services with a NFC enabled mobile device, the processing factoring in at least one effect that one or more selected value added services has on one-tap settlement, the method comprising:
receiving token data from the NFC enabled mobile device in response to the NFC enabled mobile device being placed in proximity to the NFC enabled payment machine, the token data comprising information on the effect redemption of the one or more selected value added services has on the one-tap settlement, wherein the token data is generated by a merchant server administering the one or more value added services;
communicating, with the merchant server, the token data to verify the validity of the one or more selected value added services; and
determining a cost of the purchased goods or services in response to an outcome of the verification of the validity of the one or more selected value added services.

14. The method in accordance with claim 13, wherein the cost of the purchased goods or services results from modification due to the redemption of the one or more selected value added services whose validity are successfully verified.

15. The method in accordance with claim 14, wherein successful verification of the validity of the one or more selected value added services further comprises transmitting, to the NFC enabled mobile device, detail on the manner in which the cost of the purchased goods or services is modified in response to the successfully redeemed one or more selected value added services.

16. The method in accordance with claim 13, wherein unsuccessful verification of the validity of the one or more selected value added services further comprises transmitting, to the NFC enabled mobile device, a negative indicator.

17. The method in accordance with claim 13, wherein data exchanged during the initiation and completion of the one-tap settlement occurs over an uninterrupted sequence.

18. The method in accordance with claim 13, further comprising, forwarding the cost of the purchased goods or services to an acquirer server seeking authorization of payment.

19. A merchant server for administering one or more value added services redeemed during a one-tap settlement of purchase of goods or services between a NFC enabled mobile device and a NFC enabled payment machine, the merchant server comprising:
at least one processor;
at least one memory including computer program code; and
at least one communication interface;
the at least one memory and the computer program code configured to, with at least one processor, cause the merchant server at least to:
during pre-tap processing, transmit one or more value added services to the NFC enabled mobile device, of which a selection is loaded into the NFC enabled mobile device; and
during the one-tap settlement
receive, during the one-tap settlement, token data from the NFC enabled payment machine, the token data comprising the one or more value added services selected by the NFC enabled mobile device and information on an effect redemption of the selected one or more value added services has on the one-tap settlement;
verify the validity of the one or more selected value added services; and
transmit, to the NFC enabled mobile device, an indicator of an outcome of the verification of the validity of the one or more selected value added services.

20. The merchant server of claim 19, wherein the at least one processor is further configured to, during the pre-tap processing, cause the merchant server to
generate the token data in response to receiving the one or more selected value added services, wherein the token data comprises information on the effect redemption of the selected one or more value added services has on the one-tap settlement; and
transmit the token data to the NFC enabled mobile device.

21. A NFC enabled payment machine for processing a one-tap settlement of purchase of goods or services initiated by a NFC enabled mobile device placed in proximity to the NFC enabled payment machine, the NFC enabled payment machine comprising:
at least one processor;
at least one memory including computer program code; and
at least one communication interface;
the at least one memory and the computer program code configured to, with at least one processor, cause the NFC enabled payment machine at least to:
receive, during the one-tap settlement, token data from the NFC enabled mobile device, wherein the token data comprises information on the effect redemption of the one or more selected value added services has on the one-tap settlement, wherein the token data is generated by a merchant server administering the one or more value added services;
communicate, with the merchant server, the token data to verify the validity of the one or more selected value added services; and
determine a cost of the purchased goods or services in response to an outcome of the verification of the validity of the one or more selected value added services.

22. The NFC enabled payment machine of claim 21, wherein the cost of the purchased goods or services results from modification due to the redemption of the one or more selected value added services whose validity are successfully verified.

23. The NFC enabled payment machine of claim 22, wherein successful verification of the validity of the one or more selected value added services further comprises transmitting, to the NFC enabled mobile device, detail on the manner in which the cost of the purchased goods or services is modified in response to the successfully redeemed one or more selected value added services.

24. The NFC enabled payment machine of claim 21, wherein unsuccessful verification of the validity of the one or more selected value added services further comprises transmitting, to the NFC enabled mobile device, a negative indicator.

25. A non-transitory computer readable medium having stored thereon executable instructions for controlling a computer to administer one or more value added services redeemed during a one-tap settlement of purchase of goods or services between a NFC enabled mobile device and a NFC enabled payment machine, wherein the computer is controlled to perform steps comprising:
during pre-tap processing, transmitting one or more value added services to the NFC enabled mobile device, of which a selection is loaded into the NFC enabled mobile device; and
during the one-tap settlement
receiving, during the one-tap settlement, token data from the NFC enabled payment machine, the token data comprising the one or more value added services selected by the NFC enabled mobile device and information on an effect redemption of the selected one or more value added services has on the purchased goods or services;
verifying the validity of the one or more selected value added services; and
transmitting, to the NFC enabled mobile device, an indicator of an outcome of the verification of the validity of the one or more selected value added services.

26. A non-transitory computer readable medium having stored thereon executable instructions for controlling a computer to process a one-tap settlement of purchase of goods or services initiated by a NFC enabled mobile device placed in proximity to the NFC enabled payment machine, wherein the computer is controlled to perform steps comprising:
receiving, during the one-tap settlement, token data from the NFC enabled mobile device, wherein the token data comprises information on the effect redemption of the one or more selected value added services has on the one-tap settlement, wherein the token data is generated by a merchant server administering the one or more value added services;
communicating, with the merchant server, the token data to verify the validity of the one or more selected value added services; and
determining a cost of the purchased goods or services in response to an outcome of the verification of the validity of the one or more selected value added services.
